(19) United States
(12) Patent Application Publication
(10) Pub. No.: US 2026/0295887 A1
(43) Pub. Date: Oct. 1, 2026

(54) UNIVERSAL CLAMPING DEVICE FOR CIRCULAR SAW MACHINES

(71) Applicant: Hui-Chuan LIAO, Oakland, CA (US)

(72) Inventors: Hui-Chuan LIAO, Oakland, CA (US); Yu-Chen HSIAO, Taichung City (TW); Chun-Ti WANG, Taichung City (TW)

(73) Assignee: Hui-Chuan LIAO, Oakland, CA (US)

(21) Appl. No.: 19/093,765

(22) Filed: Mar. 28, 2025

(51) Int. Cl. B27B 5/29

(52) U.S. Cl. CPC B27B 5/29

(57) ABSTRACT

A universal clamping device for circular saw machines has a body, an adjuster, and at least one fixer. The body has a cutting window, at least one slide groove, at least one adjusting groove, and a connecting recess. The adjuster is movably disposed in the connecting recess and has two limiting faces and at least one fastener. A mounting space is formed between one of the limiting faces and one of two inner sides of the connecting recess. The at least one fixer is connected to the body, is disposed in the at least one slide groove, and has a fixing slice, a positioning element, and a rotating button. The fixing slice has an engaging end and an elongated hole. The positioning element extends through the elongated hole. The rotating button is connected to the positioning element to form an engaging angle between the engaging end and the body.

### BACKGROUND OF THE INVENTION

### 1. Field of the Invention

The present invention relates to a universal clamping device, and more particularly to a universal clamping device for circular saw machines that can be used conveniently, can improve practicality, and can provide safety in clamping.

### 2. Description of Related Art

A conventional power saw is a handheld rotary cutting machine equipped with a toothed disc or a grinding wheel. The toothed disc or the grinding wheel is driven to rotate to cut a board. The conventional power saws generally include circular saw machines and track saw machines. When the circular saw machine is used to perform straight cutting on a board, in order to ensure the accuracy and quality of the cutting, it must be used with a straight edge tool such as a ruler to ensure cutting in a straight line on the board. When the track saw machine is used to perform straight cutting on a board, since a track of the track saw machine is arranged in a straight line, the track saw machine can be used to perform a straight line cutting on the board. Furthermore, in use, the straight edge tool of the circular saw machine and the track of the track saw machine are positioned and clamped by a conventional clamping device. When the conventional clamping device positions the straight edge tool or the track, it clamps and positions the straight edge tool or the track through a downward clamping mechanism.

However, to provide a straight-line cutting effect, the track of the track saw machine must be set up on the board for calibration before use, which takes time to install. Moreover, it can only be used with a corresponding track saw machine, and cannot be used with a handheld circular saw machine or track saw machines of different sizes, which relatively limits its practicality. In addition, the overall size of the track saw machine is inconvenient to carry and store. In view of this, when cutting a board in a straight line, the handheld circular saw machine can only be used with a straight edge tool, and the track saw machine can only be used with a corresponding track. Therefore, it is not possible to use a single clamping device for the handheld circular saw machines and the track saw machine, which is relatively inconvenient to use and increases the cost required for use. Furthermore, the conventional clamping device keeps the straight edge tool or the track in position by a downward pressure. The friction force of the downward pressure exerts load pressure on the conventional clamping device, the straight edge tool, and the track, which may easily damage or break the conventional clamping device, the straight edge tool or the track. Since the conventional clamping device for the circular saw machine and the track saw machine has the above-mentioned problems and shortcomings, the conventional clamping device needs to improve.

The universal clamping device for circular saw machines in accordance with the present invention mitigates or obviates the aforementioned problems.

### SUMMARY OF THE INVENTION

The main objective of the present invention is to provide a universal clamping device for circular saw machines that can be used conveniently, can improve practicality, and can provide safety in clamping.

The universal clamping device for circular saw machines in accordance with the present invention has a body, an adjuster, and at least one fixer. The body has a cutting window, at least one slide groove, at least one adjusting groove, and a connecting recess. The adjuster is movably disposed in the connecting recess of the body and has two limiting faces, a mounting space, and at least one fastener. The mounting space is formed between one of the two limiting faces and one of two inner sides of the connecting recess. The at least one fixer is connected to the body, is disposed in the at least one slide groove, and has a fixing slice, a positioning element, and a rotating button. The fixing slice has an engaging end being obliquely disposed and an elongated hole. The positioning element extends through the elongated hole. The rotating button is connected to the positioning element to form an engaging angle between the engaging end of the fixing slice and the top side of the body.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a universal clamping device for circular saw machines in accordance with the present invention;

FIG. 2 is another perspective view of the universal clamping device for circular saw machines in FIG. 1;

FIG. 3 is an exploded perspective view of the universal clamping device for circular saw machines in FIG. 1;

FIG. 4 is an enlarged side view in partial section of the universal clamping device for circular saw machines in FIG. 1;

FIG. 5 is another enlarged side view in partial section of the universal clamping device for circular saw machines in FIG. 1;

FIG. 6 is an operational side view in partial section of the universal clamping device for circular saw machines in FIG. 1, connected to a circular saw machine;

FIG. 7 is an enlarged and operational side view in partial section of the universal clamping device for circular saw machines in FIG. 6;

FIG. 8 is another enlarged and operational side view in partial section of the universal clamping device for circular saw machines in FIG. 6;

FIG. 9 is a further enlarged and operational side view in partial section of the universal clamping device for circular saw machines in FIG. 6;

FIG. 10 is an operational bottom side view of the universal clamping device for circular saw machines in FIG. 6, connected to a straight edge tool;

FIG. 11 is an operational bottom side view of the universal clamping device for circular saw machines in FIG. 6, connected to a track of a track saw machine;

FIG. 12 is a perspective view of a second embodiment of a universal clamping device for circular saw machines in accordance with the present invention;

FIG. 13 is an enlarged and exploded perspective view of the universal clamping device for circular saw machines in FIG. 12; and

FIG. 14 is an enlarged side view in partial section of the universal clamping device for circular saw machines in FIG. 12.

### DETAILED DESCRIPTION OF THE PREFERRED EMBODIMENT

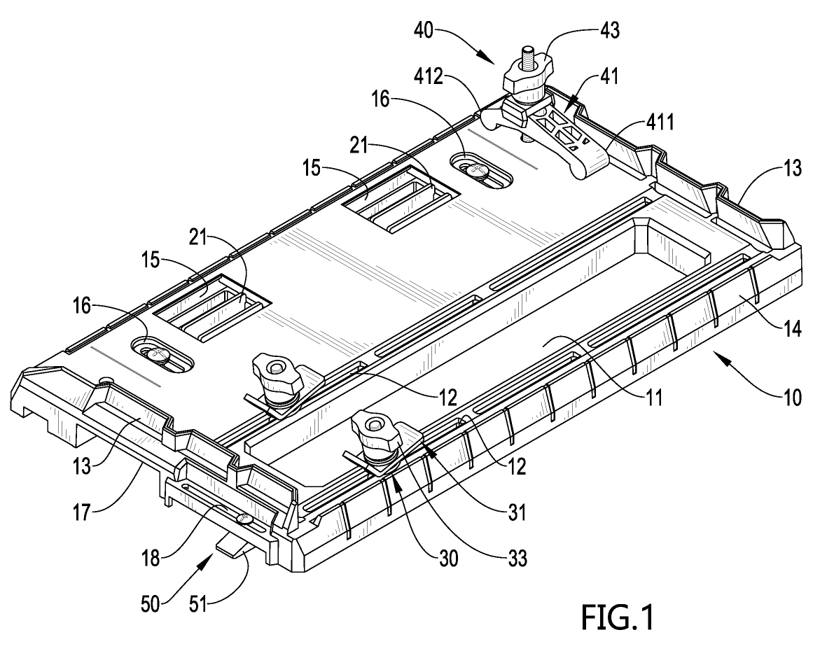

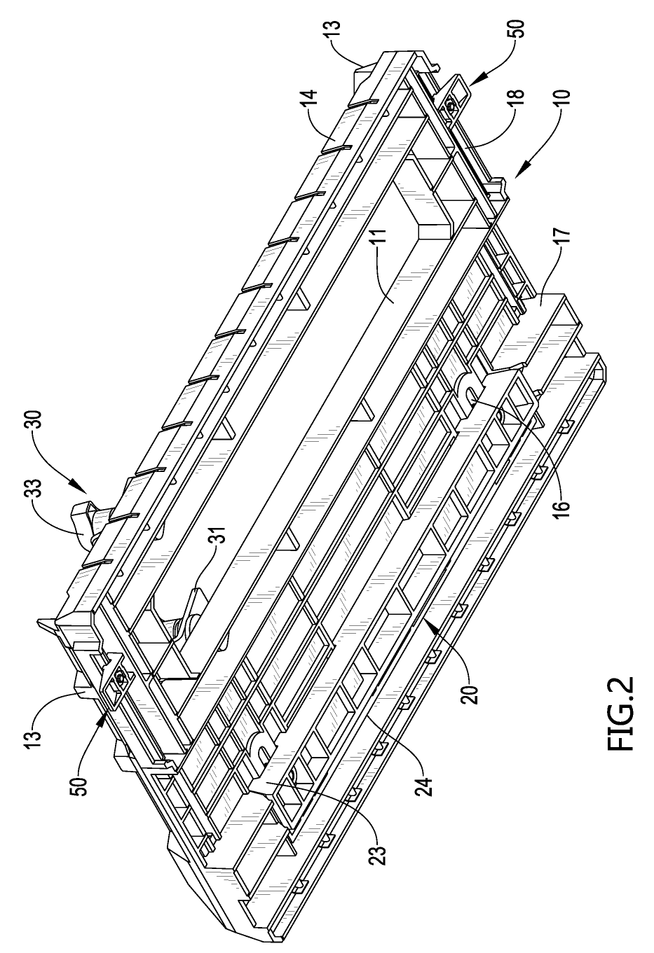

With reference to FIGS. 1-3, a first embodiment of a universal clamping device for circular saw machines in accordance with the present invention has a body 10, an adjuster 20, at least one fixer 30, at least one clamper 40, and at least one pointer 50.

With reference to FIGS. 1-3, the body 10 is a strip-shaped board and has a cutting window 11, at least one slide groove 12, at least one baffle 13, at least one side plate 14, at least one pushing window 15, at least one adjusting groove 16, a connecting recess 17, and at least one pointing slot 18. The cutting window 11 is formed through a top side and a bottom side of the body 10 along a length direction of the body 10 adjacent to a length side of the body 10. The at least one slide groove 12 is formed through the top side and the bottom side of the body 10 at a side of the cutting window 11. Furthermore, the body 10 has two said slide grooves 12 respectively disposed on two sides of the cutting window 11. In addition, the body 10 has multiple said slide grooves 12 disposed at spaced intervals at each one of the two sides of the cutting window 11 along the length direction of the body 10.

The at least one baffle 13 is inclinedly formed on and protrudes from the top side of the body 10 at a width side of the body 10 and extends along a width direction of the body 10, such that an angle less than 90 degrees is formed between the at least one baffle 13 and the top side of the body 10. Furthermore, the body 10 has two said baffles 13 formed on and protruded from the top side of the body 10 respectively at two width sides of the body 10, such that the cutting window 11 is located between the two said baffles 13. The at least one side plate 14 is formed on and protrudes from the top side of the body 10 along the length direction of the body 10 at a length side of the body 10 between the two said baffles 13 and is disposed adjacent to the cutting window 11.

The at least one pushing window 15 is formed through the top side and the bottom side of the body 10 away from the cutting window 11. Furthermore, the body 10 has two said pushing windows 15 formed through the body 10 at a spaced interval between the two said baffles 13. The at least one adjusting groove 16 is elongated and is formed through the top side and the bottom side of the body 10 adjacent to the at least one pushing window 15. Additionally, the body 10 has two said adjusting grooves 16 formed through the body 10 and are respectively disposed adjacent to the two said pushing windows 15. Furthermore, the two said pushing windows 15 are disposed between the two said adjusting grooves 16.

The connecting recess 17 is formed in the bottom side of the body 10 and spatially communicates with the two said pushing windows 15 and the two said adjusting grooves 16. The at least one pointing slot 18 is formed through the body 10 along the width direction of the body 10 at an end of the cutting window 11. Furthermore, the body 10 has two said pointing slots 18 formed through the body 10 along the width direction of the body 10 and are respectively disposed at two ends of the cutting window 11.

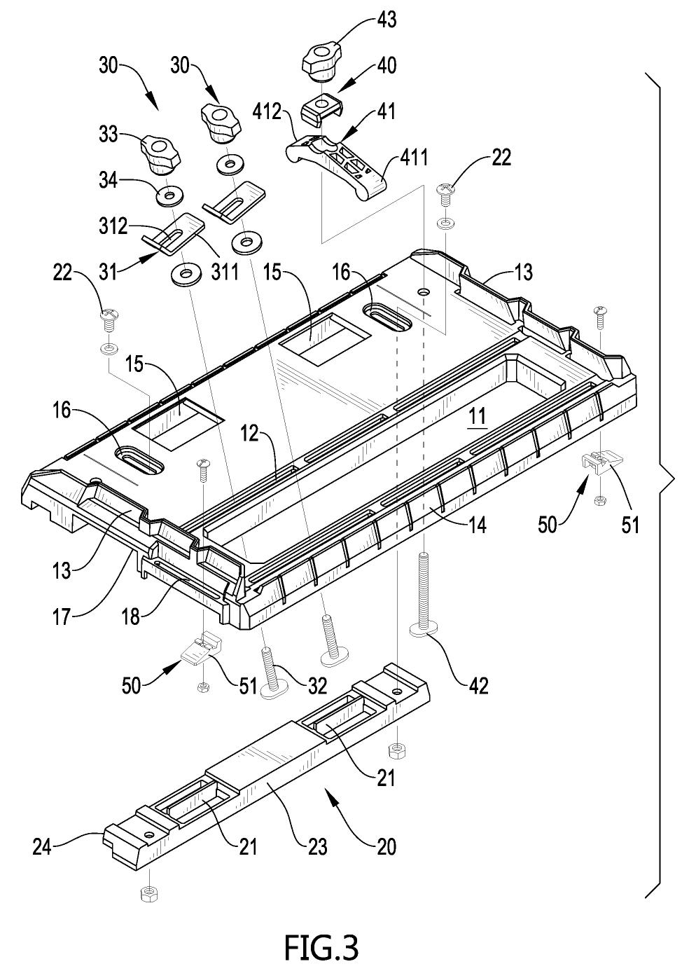

With reference to FIGS. 1 and 3, the adjuster 20 is movably disposed in the connecting recess 17 of the body 10, and has at least one pushing stem 21 and at least one fastener 22. The at least one pushing stem 21 is disposed on a top of the adjuster 20 and extends out of the top side of the body 10 via the at least one pushing window 15. Furthermore, the adjuster 20 has two said pushing stems 21 disposed on the top of the adjuster 20 at a spaced interval and are respectively extended out of the two said pushing windows 15 of the body 10, such that a user can move the adjuster 20 relative to the body 10 in the connecting recess 17 by pushing the two said pushing stems 21. The adjuster 20 has two limiting faces 23, 24 respectively formed on two sides of the adjuster 20 along a length direction of the adjuster 20. A mounting space is formed between one of the two limiting faces 23, 24 and one of two inner sides of the connecting recess 17 or formed between the other one of the two limiting faces 23, 24 and the other one of the two inner sides of the connecting recess 17. The size of the mounting space can be adjusted according to the position of the adjuster 20 relative to the body 10. Furthermore, the two limiting faces 23, 24 are respectively a first limiting face 23 and a second limiting face 24. The at least one fastener 22 is connected securely to the adjuster 20 via the at least one adjusting groove 16 of the body 10. After the adjuster 20 is moved relative to the body 10, the adjuster 20 can be fixed in the connecting recess 17 of the body 10 via the at least one fastener 22, thereby limiting the size of the mounting space. In addition, the adjuster 20 has two said fasteners 22 connected to the adjuster 20 respectively via the two said adjusting grooves 16.

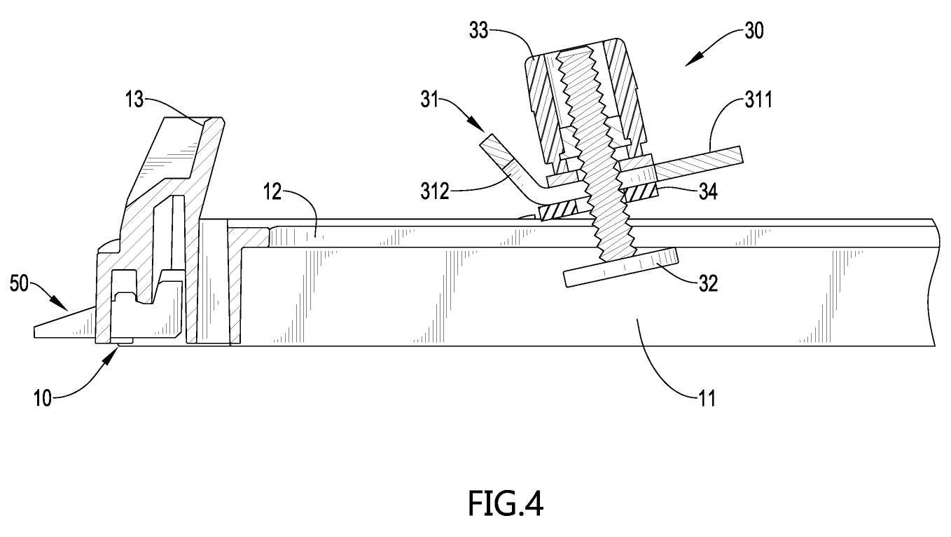

With reference to FIGS. 1, 3 and 4, the at least one fixer 30 is connected to the body 10, is disposed in the at least one slide groove 12, and has a fixing slice 31, a positioning element 32, and a rotating button 33. The fixing slice 31 may be V-shaped and has an engaging end 311 and an elongated hole 312. The engaging end 311 of the fixing slice 31 is obliquely disposed, and the elongated hole 312 is formed through the fixing slice 31 and spatially communicates with the at least one slide groove 12. The positioning element 32 extends through the elongated hole 312 of the fixing slice 31 from the bottom side of the body 10 via the at least one slide groove 12. The rotating button 33 is connected to the positioning element 32 to hold the fixing slice 31 securely on the top side of the body 10 by the rotating button 33 abutting against the fixing slice 31 and the positioning element 32 abutting against the bottom side of the body 10. Then an engaging angle is formed between the engaging end 311 of the fixing slice 31 and the top side of the body 10. Furthermore, the at least one fixer 30 has at least one washer 34 disposed between the rotating button 33 and the fixing slice 31. Additionally, the universal clamping device for circular saw machines of the present invention has two said fixers 30 respectively disposed on the two sides of the cutting window 11.

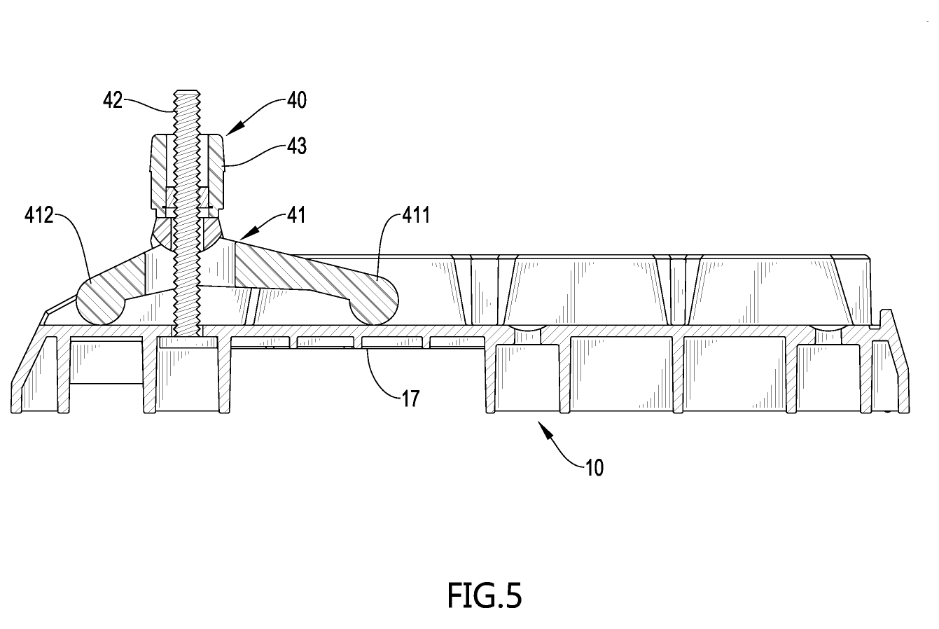

With reference to FIGS. 1, 3, and 5, the at least one clamper 40 is connected to the body 10 adjacent to the at least one adjusting groove 16, and has a clamping element 41, a limiting element 42, and a locking button 43. The clamping element 41 is disposed on the top side of the body 10 and has a first pressing end 411 and a second pressing end 412. The two pressing ends 411, 412 have different lengths. Preferably, the length of the first pressing end 411 is longer than the length of the second pressing end 412. The limiting element 42 extends out of the top side of the body 10 and the clamping element 41 from the bottom side of the body 10 via the connecting recess 17. The locking button 43 is connected to the limiting element 42 to position the clamping element 41 on the top side of the body 10. Preferably, the universal clamping device for circular saw machines of the present invention has two said clampers 40 disposed on the top side of the body 10 at a spaced interval and respectively disposed adjacent to the two said adjusting grooves 16.

With reference to FIGS. 1 and 3, the at least one pointer 50 is connected to the body 10, is disposed in the at least one pointing slot 18, and is moved relative to the body 10 along the at least one pointing slot 18 to change the position of the at least one pointer 50 relative to the cutting window 11 of the body 10. The at least one pointer 50 has a cutting positioning surface 51 formed on a side of the at least one pointer 50. Preferably, the universal clamping device for circular saw machines of the present invention has two said pointers 50 respectively disposed in the two said pointing slots 18 of the body 10, such that the cutting window 11 is disposed between the two said pointers 50.

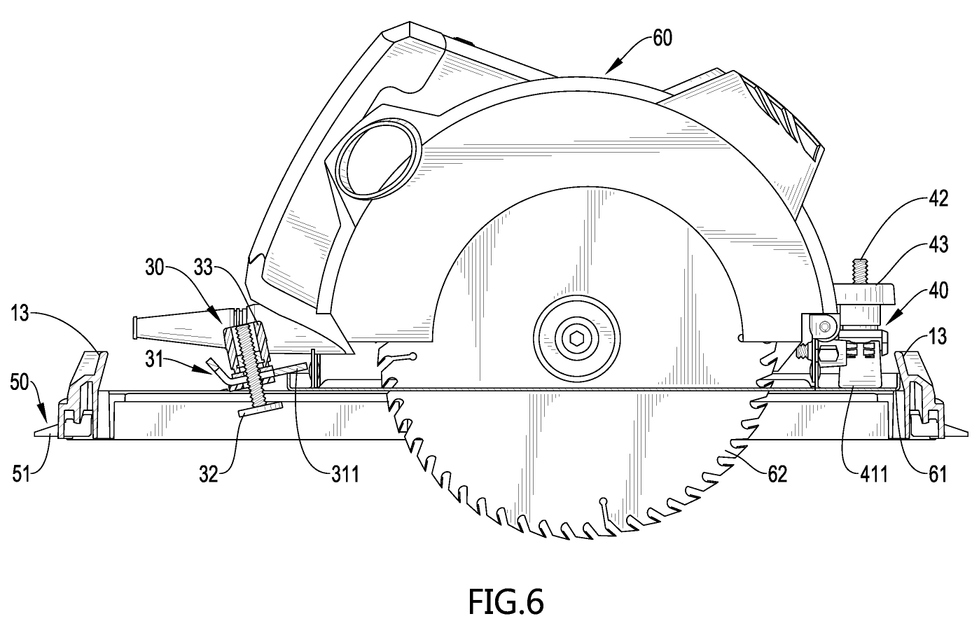

With reference to FIG. 6, when the first embodiment of the universal clamping device for circular saw machines of the present invention is in use, firstly, a circular saw machine 60 (a handheld circular saw machine or a track saw machine) is disposed on the top side of the body 10, one of two sides of a base 61 of the circular saw machine 60 abuts against one of the two said baffles 13, and the other one of the two sides of the base 61 engages with the engaging end 311 of the fixing slice 31 of the at least one fixer 30. Then the two sides of the base 61 are held securely between the corresponding baffle 13 and the at least one fixer 30. A saw blade 62 of the circular saw machine 60 extends out of the bottom side of the body 10 via the cutting window 11.

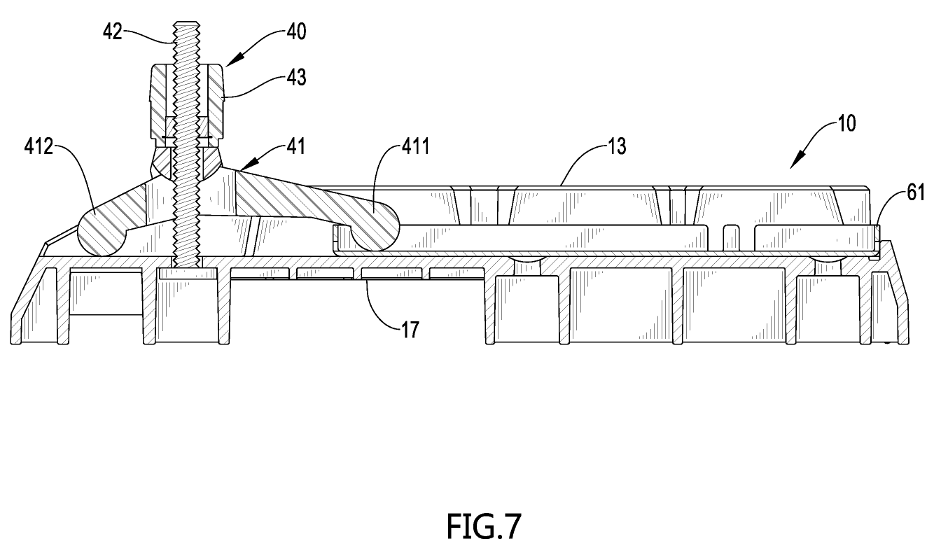

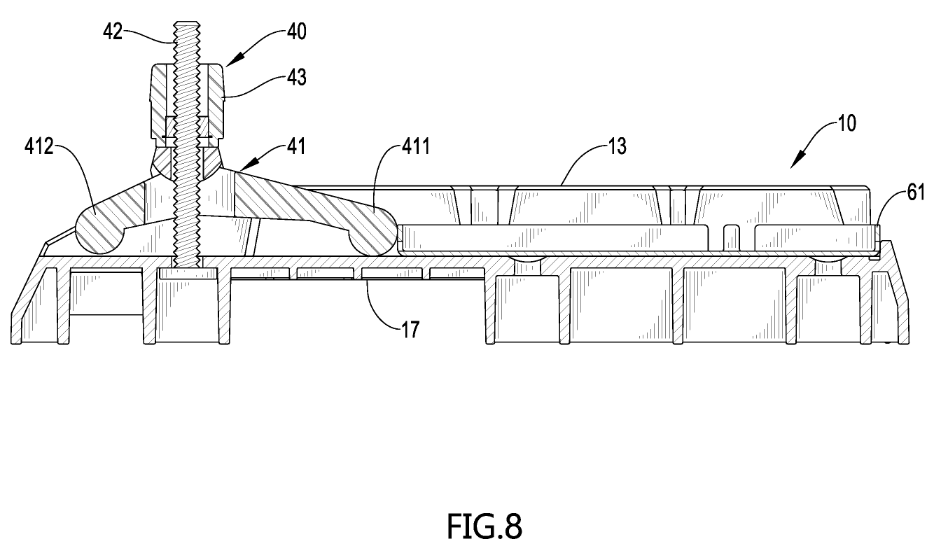

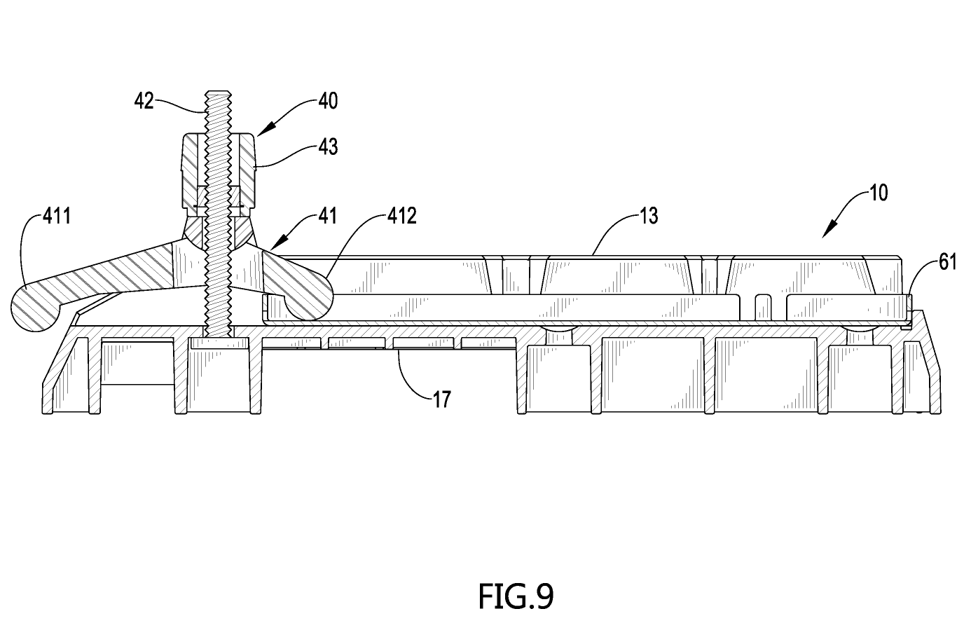

With reference to FIG. 7, the clamping element 41 of the at least one clamper 40 can further clamp the base 61 to provide a three-point positioning effect to the base 61 of the circular saw machine 60. Then the circular saw machine 60 can be securely held on the top side of the body 10 conveniently and quickly by the at least one baffle 13, the at least one fixer 30, and the at least one clamper 40. Furthermore, the clamping element 41 clamps the base 61 by the first pressing end 411 abutting against an inner side of the base 61 as shown in FIG. 7 or abutting against an outer side of the base 61 as shown in FIG. 8. In addition, with reference to FIG. 9, according to the base 61 of the circular saw machine 60 of different sizes, a clamping effect can be provided via the second pressing end 412 of the clamping element 41.

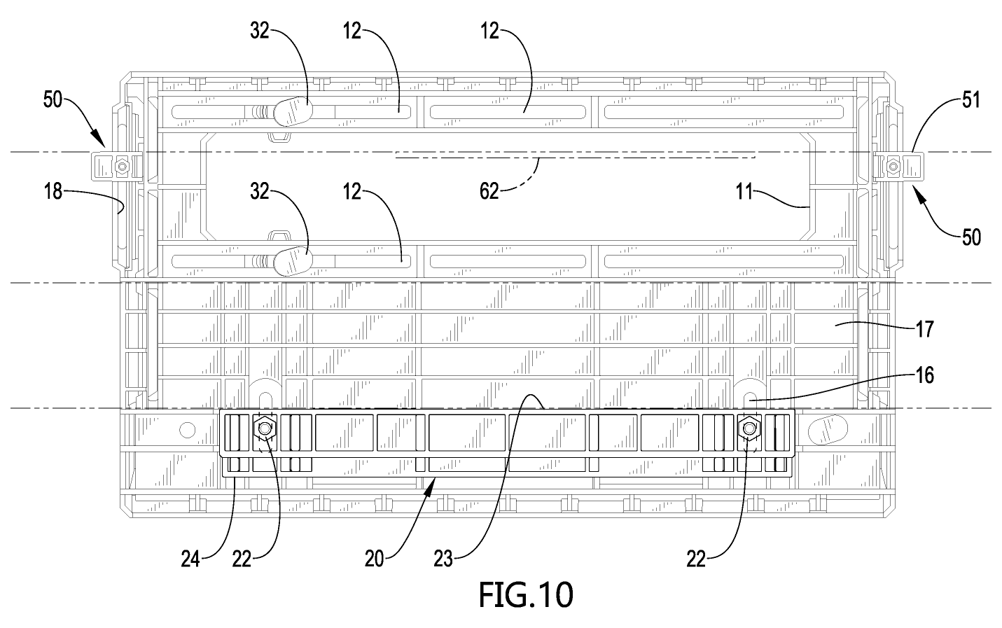

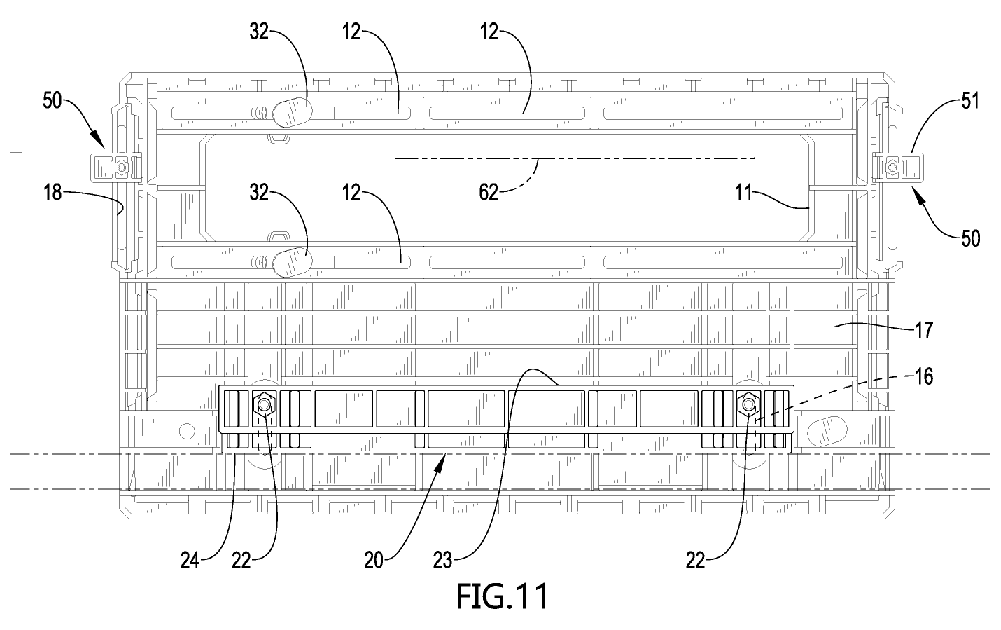

With reference to FIGS. 10 and 11, when the circular saw machine 60 is securely held on the body 10 by the corresponding baffle 13, the at least one fixer 30, and the at least one clamper 40, the size of the mounting space can be adjusted according to size of a straight edge tool or a track of a track saw machine by moving the adjuster 20 relative to the body 10 in the connecting recess 17. With reference to FIG. 10, when the circular saw machine 60 is used to make a straight-line cutting on a board with the straight edge tool, the two fasteners 22 are loosened and the adjuster 20 is moved in the connecting recess 17 by pushing the two pushing stems 21 as shown in FIG. 1. Then the mounting space that matches the size of the straight edge tool is formed between the first limiting face 23 and one of the two inner sides of the connecting recess 17. At this time, after fastening the two fasteners 22, the body 10 can be mounted on the straight edge tool by the mounting space. Furthermore, with reference to FIG. 11, when the track saw machine is used with the universal clamping device of the present invention, the adjuster 20 is moved relative to the body 10 such that the mounting space that matches the size of the track of the track saw machine is formed between the second limiting face 24 and the other one of the two inner sides of the connecting recess 17. At this time, after fastening the two fasteners 22, the body 10 can be mounted on the track by the mounting space, which is convenient and quick in use. At the same time, a user can accurately grasp the position of the linear cutting by the pointers 50 that linearly align with a saw blade 62 of the circular saw machine 60.

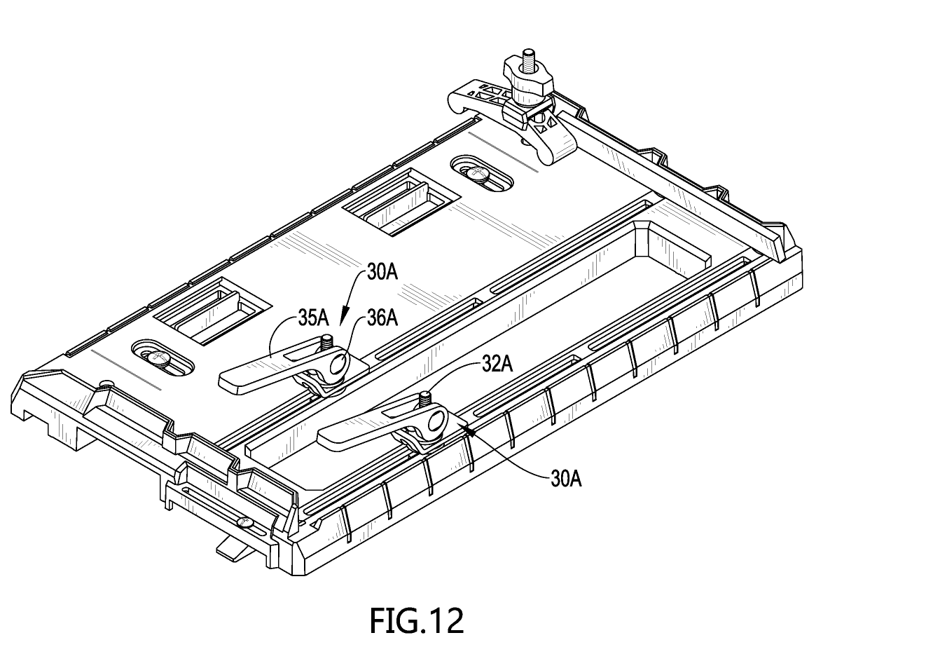

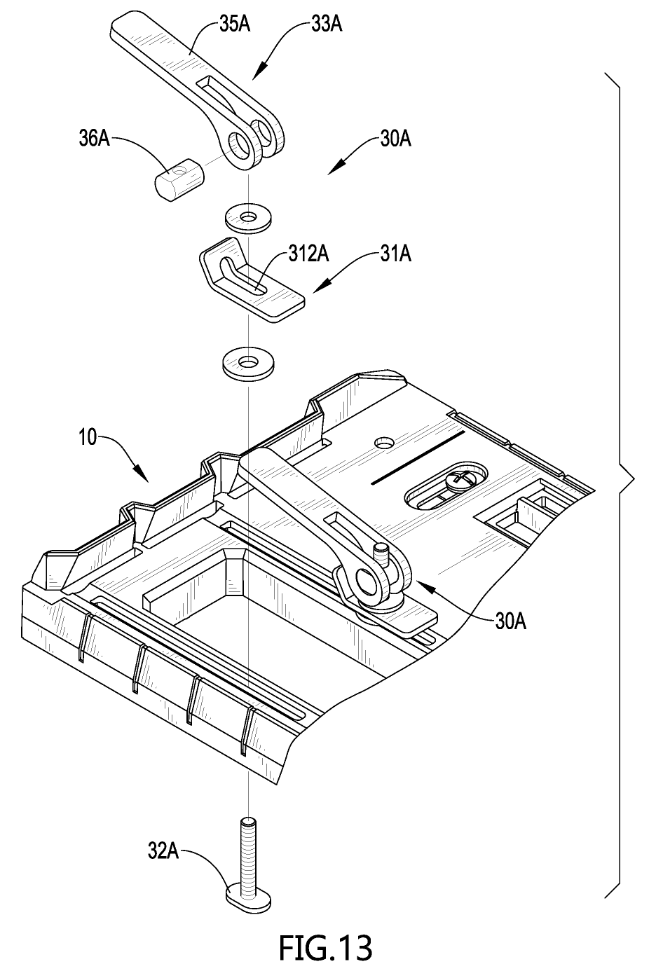

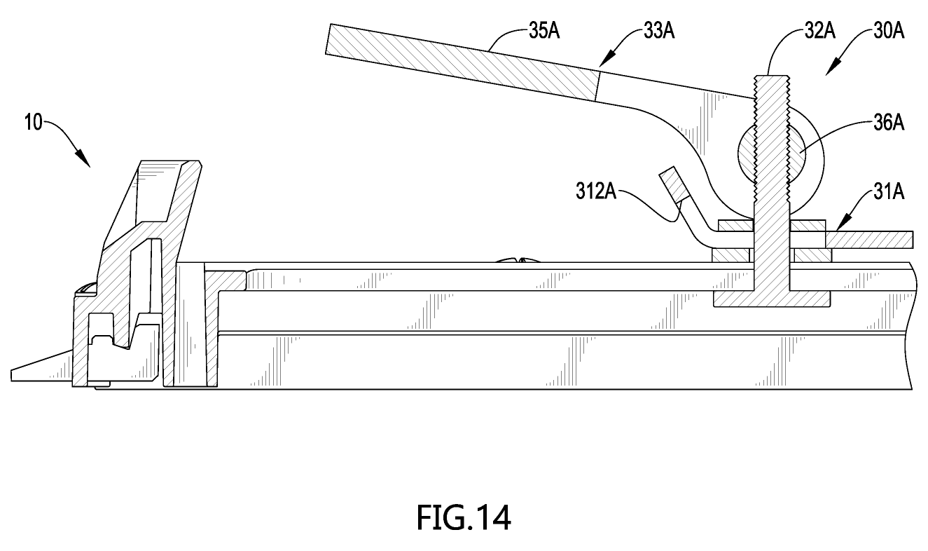

With reference to FIGS. 12-14, a second embodiment of a universal clamping device for circular saw machines in accordance with the present invention is substantially the same as the first embodiment as shown in FIGS. 1-3 except for the following features. In the second embodiment of the universal clamping device for circular saw machines of the present invention, the rotating button 33A of the at least one fixer 30A has a handle 35A and a cam block 36A. The cam block 36A is disposed on an end of the handle 35A and is connected to the positioning element 32A that extends through the elongated hole 312A of the fixing slice 31A. The handle 35A is pivoted relative to the fixing slice 31A, and the positioning element 32A is driven to abut against the bottom side of the body 10 via the cam block 36A.

According to the above-mentioned structural relationships and features of the universal clamping device for circular saw machines of the present invention, in use, the baffles 13, the fixers 30, 30A, and the clamper 40 can hold the circular saw machine 60 securely on the body 10, and this is convenient and quick in use. Furthermore, by moving the adjuster 20 relative to the body 10 in the connecting recess 17, the universal clamping device of the present invention can be adapted to straight edge tools and tracks of different sizes, and can be used by circular saw machines 60 and track circular saw machines at the same time, greatly improving practicality. In addition, the fixing slice 31, 31A of the fixer 30, 30A has an obliquely-disposed engaging end 311 to inclinedly engage and press against the base 61 of the circular saw machine 60, and this can provide both downward and forward compressive forces to avoid the load pressure of a single downward friction force, which can effectively avoid the risk of damage or breakage of the clamping device, the straight edge tools or the tracks. Therefore, the present invention provides a universal clamping device for circular saw machines that can be used conveniently, can improve practicality, and can provide safety in clamping.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A universal clamping device for circular saw machines comprising:
a body having
a cutting window formed through a top side and a bottom side of the body along a length direction of the body;
at least one slide groove formed through the top side and the bottom side of the body at a side of the cutting window;
at least one adjusting groove formed through the top side and the bottom side of the body; and
a connecting recess formed in the bottom side of the body and spatially communicating with the at least one adjusting groove;
an adjuster movably disposed in the connecting recess of the body and having
two limiting faces respectively formed on two sides of the adjuster along a length direction of the adjuster;
a mounting space formed between one of the two limiting faces and one of two inner sides of the connecting recess and being size-adjustable according to a position of the adjuster relative to the body; and
at least one fastener connected securely to the adjuster via the at least one adjusting groove of the body to hold the adjuster securely in the connecting recess of the body to limit the size of the mounting space; and
at least one fixer connected to the body, disposed in the at least one slide groove, and having
a fixing slice having
an engaging end being obliquely disposed; and
an elongated hole formed through the fixing slice and spatially communicating with the at least one slide groove;

2. The universal clamping device for circular saw machines as claimed in claim 1, wherein
the universal clamping device has at least one clamper connected to the body adjacent to the at least one adjusting groove; and
the at least one clamper has
a clamping element disposed on the top side of the body and having
a first pressing end; and
a second pressing end;
a limiting element extending out of the top side of the body and the clamping element from the bottom side of the body via the connecting recess; and
a locking button connected to the limiting element to position the clamping element on the top side of the body.

3. The universal clamping device for circular saw machines as claimed in claim 2, wherein the two pressing ends of the clamping element have different lengths.

4. The universal clamping device for circular saw machines as claimed in claim 1, wherein
the body has at least one pointing slot formed through the body along a width direction of the body at an end of the cutting window; and
the universal clamping device has at least one pointer connected to the body, disposed in the at least one pointing slot, being moveable relative to the body along the at least one pointing slot to change a position of the at least one pointer relative to the cutting window of the body, and having a cutting positioning surface formed on a side of the at least one pointer.

5. The universal clamping device for circular saw machines as claimed in claim 2, wherein
the body has at least one pointing slot formed through the body along a width direction of the body at an end of the cutting window; and
the universal clamping device has at least one pointer connected to the body, disposed in the at least one pointing slot, being moveable relative to the body along the at least one pointing slot to change a position of the at least one pointer relative to the cutting window of the body, and having a cutting positioning surface formed on a side of the at least one pointer.

6. The universal clamping device for circular saw machines as claimed in claim 3, wherein
the body has at least one pointing slot formed through the body along a width direction of the body at an end of the cutting window; and
the universal clamping device has at least one pointer connected to the body, disposed in the at least one pointing slot, being moveable relative to the body along the at least one pointing slot to change a position of the at least one pointer relative to the cutting window of the body, and having a cutting positioning surface formed on a side of the at least one pointer.

7. The universal clamping device for circular saw machines as claimed in claim 1, wherein the body has multiple said slide grooves disposed at spaced intervals at each one of the two sides of the cutting window along the length direction of the body.

8. The universal clamping device for circular saw machines as claimed in claim 2, wherein the body has multiple said slide grooves disposed at spaced intervals at each one of the two sides of the cutting window along the length direction of the body.

9. The universal clamping device for circular saw machines as claimed in claim 1, wherein the body has
at least one baffle inclinedly formed on and protruded from the top side of the body at a width side of the body and extended along a width direction of the body;
an angle being less than 90 degrees formed between the at least one baffle and the top side of the body; and
at least one side plate formed on and protruded from the top side of the body along the length direction of the body at a length side of the body, and disposed adjacent to the cutting window.

10. The universal clamping device for circular saw machines as claimed in claim 2, wherein the body has
at least one baffle inclinedly formed on and protruded from the top side of the body at a width side of the body and extended along a width direction of the body;
an angle being less than 90 degrees formed between the at least one baffle and the top side of the body; and
at least one side plate formed on and protruded from the top side of the body along the length direction of the body at a length side of the body, and disposed adjacent to the cutting window.

11. The universal clamping device for circular saw machines as claimed in claim 9, wherein
the body has two said baffles formed on and protruded from the top side of the body respectively at two width sides of the body;
the cutting window is located between the two said baffles; and
the at least one side plate is disposed between the two said baffles.

12. The universal clamping device for circular saw machines as claimed in claim 10, wherein
the body has two said baffles formed on and protruded from the top side of the body respectively at two width sides of the body;
the cutting window is located between the two said baffles; and
the at least one side plate is disposed between the two said baffles.

13. The universal clamping device for circular saw machines as claimed in claim 1, wherein
the body has at least one pushing window formed through the top side and the bottom side of the body away from the cutting window; and
the adjuster has at least one pushing stem disposed on a top of the adjuster and extending out of the top side of the body via the at least one pushing window.

14. The universal clamping device for circular saw machines as claimed in claim 2, wherein
the body has at least one pushing window formed through the top side and the bottom side of the body away from the cutting window; and
the adjuster has at least one pushing stem disposed on a top of the adjuster and extending out of the top side of the body via the at least one pushing window.

15. The universal clamping device for circular saw machines as claimed in claim 3, wherein
the body has at least one pushing window formed through the top side and the bottom side of the body away from the cutting window; and
the adjuster has at least one pushing stem disposed on a top of the adjuster and extending out of the top side of the body via the at least one pushing window.

16. The universal clamping device for circular saw machines as claimed in claim 13, wherein
the body has
two said pushing windows formed through the body at a spaced interval; and
two said adjusting grooves formed through the body and respectively disposed adjacent to the two said pushing windows; and
the adjuster has
two said pushing stems disposed on the top of the adjuster at a spaced interval and respectively extended out of the two said pushing windows of the body; and
two said fasteners connected to the adjuster respectively via the two said adjusting grooves.

17. The universal clamping device for circular saw machines as claimed in claim 14, wherein
the body has
two said pushing windows formed through the body at a spaced interval; and
two said adjusting grooves formed through the body and respectively disposed adjacent to the two said pushing windows; and
the adjuster has
two said pushing stems disposed on the top of the adjuster at a spaced interval and respectively extended out of the two said pushing windows of the body; and
two said fasteners connected to the adjuster respectively via the two said adjusting grooves.

18. The universal clamping device for circular saw machines as claimed in claim 15, wherein
the body has
two said pushing windows formed through the body at a spaced interval; and
two said adjusting grooves formed through the body and respectively disposed adjacent to the two said pushing windows; and
the adjuster has
two said pushing stems disposed on the top of the adjuster at a spaced interval and respectively extended out of the two said pushing windows of the body; and
two said fasteners connected to the adjuster respectively via the two said adjusting grooves.

19. The universal clamping device for circular saw machines as claimed in claim 1, wherein the rotating button of the at least one fixer has
a handle; and
a cam block disposed on an end of the handle and connected to the positioning element that extends through the elongated hole of the fixing slice.

20. The universal clamping device for circular saw machines as claimed in claim 2, wherein the rotating button of the at least one fixer has
a handle; and
a cam block disposed on an end of the handle and connected to the positioning element that extends through the elongated hole of the fixing slice.
